(19) United States
(12) Patent Application Publication
(10) Pub. No.: US 2006/0184643 A1
(43) Pub. Date: Aug. 17, 2006

(54) Method for making and selling signs and charts

(76) Inventor: Charles Berman, Derwood, MD (US)

Correspondence Address: EDELL, SHAPIRO & FINNAN, LLC, 1901 RESEARCH BOULEVARD, SUITE 400, ROCKVILLE, MD, 20850, US

(21) Appl. No.: 11/344,528

(22) Filed: Feb. 1, 2006

Related U.S. Application Data
(60) Provisional application No. 60/648,432, filed on Feb. 1, 2005.

(51) Int. Cl. G06F 15/16

(52) U.S. Cl. 709/217

(57) ABSTRACT

A method and system of generating a printed medium such as a sign, chart, or banner is disclosed. The system includes software configured to permit a user define parameters used in creating a printed medium. The software includes several modes of operation. In a Banner Builder Mode, the customer chooses from thousands of professional designs and customizes his/her own message. In a Photo Finish mode, the customer creates a high-quality banner, sign, or chart from his/her own favorite photos. In a Banner Bazaar Mode, the customer selects from a stock of ready-made banners, signs, and charts. Finally, in a Big Design Mode, the customer designs his/her own banner, sign or chart on a Mac or PC using his/her own software.

### CROSS-REFERENCE TO RELATED APPLICATIONS

This application claims priority from U.S. Provisional Patent Application Ser. No. 60/648,432, filed Feb. 1, 2005 and entitled “Method for Making and Selling Signs and Charts”. The disclosure of the above-mentioned provisional application is incorporated herein by reference in its entirety.

### FIELD OF THE INVENTION

The present invention relates to a system and method for creating and selling printed media, and in particular to a system and method of creating signage (charts, banners, etc.).

### REFERENCE TO A COMPUTER PROGRAM

Submitted herewith is a compact disc (in duplicate) bearing the title “Method for Making & Selling Signs & Charts”. The contents of that disc are expressly incorporated into this application.

### BACKGROUND

The present invention, referred to herein as “Big Banner™”, is a fast, easy and flexible method of selling large banners, signs and charts on the Internet. By means of the present invention, a customer can have a custom sign, table or chart designed, printed, and ready for delivery from an internet proprietor.

The present invention revolutionizes banner, sign and chart printing with high-quality, affordable signs and charts for any occasion, whether a customer's own design for a personal moment or for a business event. The banners, signs, and charts can be used, for example, to advertise a service, announce a grand opening, or celebrate a milestone event in style.

### BRIEF SUMMARY OF THE INVENTION

There are four major features of the invention:

1. Big Banner Builder™—The customer chooses from thousands of professional designs and customizes his/her own message.

2. Big Photo Finish—The customer creates a high-quality banner, sign, or chart from his/her own favorite photos.

3. Big Banner Bazaar™—The customer selects from a stock of ready-made banners, signs, and charts.

4. My Big Design—The customer designs his/her own banner, sign or chart on a Mac or PC using his/her own software.

### BRIEF DESCRIPTION OF THE DRAWINGS

FIG. 1 illustrates an exemplary interactive display screen according to one embodiment of the invention.

FIG. 2 illustrates an exemplary software generated template for use by a customer in generating a printed medium.

### DETAILED DESCRIPTION

A system embodying the present invention resides in the disc appended hereto. The following description is a narrative of the operation of that system.

Big Banner Builder™

With Big Banner Builder™, creating personalized, high-impact signs and charts has never been easier. An intuitive three-step process lets the customer create his/her own sign or chart in minutes.

The process involves the following series of prompts and responses thereto:
Select a background from extensive stored image gallery.
Add your message using our intuitive text tool.
Proof and send.

To start: Select a horizontal or vertical banner, sign or chart. Then click “Next” to see available designs click on the theme of your choice.

Examples of themes for selection:

Armed Services
Army
Marines
Navy

Corporate
Baseball
Conventions
Golf
Soccer
Tech
Trade Shows

Government
Army
Civic
Community
Golf
Independence Day
Marines
Navy

Tech
Holidays
Chanukah
Golf
Halloween
Independence Day
St. Patrick's Day

Music
Rock & Roll

Non-Profit
Casino Night
Diving
Golf
Soccer
Tech

Personal
Anniversary
Baseball
Birthday
Congratulations
Diving
Golf
Graduation
Hobby
New Baby
Parties
Retirement
Reunions
Soccer
Tech
Wall Art

Retail
Automobile
Back To School
Catering
Coffee House
Construction
Golf
Hospitality
Hotel
Marine Dealerships
Motel
Real Estate
Restaurant
Sales
Soccer
Tech

Schools
Back To School
Baseball
Basketball
Diving
Golf
Graduation
Soccer
Tech

Sporting
Baseball
Basketball
Boy Scouts
Diving
Golf
Hobby
Little League
Recreational
Ski
Soccer
Swim Team

To begin customizing a banner, sign or chart, the customer is prompted to click on the design of his/her choice.

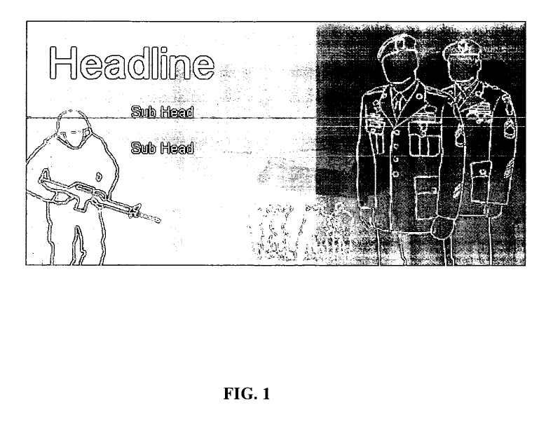

For example, if the customer chooses ARMY, the screen illustrated in FIG. 1 will appear. After selecting the text for the “HEAD”, “Sub-heads”, and image, the customer is prompted to login with his/her own user name and password. If the customer has not previously registered with the site, a conventional site registration process is provided. The customer is the shown an image of what he/she selected and prompted to complete the purchase, also in a conventional manner, by credit card or other form of payment.

A gallery of banners, sign, and charts is provided on the site and can be accessed by a mouse click. This feature permits the customer to explore the proprietor's stored banners, sign, and charts and select the ones he/she desires.

Special Features

In the preferred embodiment, the customer can print any design up to a height of, for example, 59 inches and a length of 16 feet. Of course, other size limitations may be imposed by the proprietor.

Printing is typically done on quality vinyl and window-cling polyester film, but other media can be utilized.

A brilliant and durable solvent ink is preferably utilized to render a professional product.

Past orders can be retrieved so that a customer can retrieve his/her order history at any time.

Every order is archived so that the customer can receive a saved file or obtain a reprint of an archived file.

Each banner, sign, or chart is prepared for printing by professionals trained to produce superior work.

Uploading and File Preparation

Preparing files for printing is easy. The key is to prepare a file format that does not have separate elements (fonts or pictures) and is ready to print. The customer is urged, on the site, to follow these guidelines for preparing files:

The proprietor accepts EPS, TIFF, PDF, or CorelDraw (CDR) or other pre-specified files.
Be sure that the layout is how you want it to appear on your banner.
Your file should be named in the following format: lastname_firstname_w×h (width×height). For example: smith_robert_{—}10×5.cdr
Your file may be sent to the proprietor at ⅓the final output size to allow you easier manipulation of the file on your computer, as well as faster uploading. For example, if the final size of your banner, sign or chart is 9′×3′, your working file can be set up as 3′×1′.
Be sure that all text has been carefully proofread for correct dates, times, spelling, grammar, and punctuation.

In order to achieve a swift turnaround and keep prices low, all files are uploaded via the website. If a customer is able to visit the proprietor's retail store, however, he/she can bring his/her design on a CD, DVD, or the equivalent.

Scanned photos and digital pictures that are included in the banner, sign or chart design should be scanned according to this formula:
Final Size (inches)/Original Size (inches)=‘Scan Multiple’×150=Scan DPI
For example: A popular photo size is 8″×10″. To scan that picture to include in the design, first determine the size you want it to be (3′), divide it by the original size (8″) and multiply by 150 dpi. This will give you the scan size in dots per inch to set your scanner at.

For a 3′ image—36″ divided by 8″=4.5×150=675

For a 4′ image—48″ divided by 8″=6×150=900

TABLE I
Graphical representation of the same formula for an 8″ × 10″ photograph.

| Final Size | | | Scan Dots |
|---|---|---|---|
| in Banner (Inches) | Original Size (Inches) | Multiple | per Inch (DPI) |
| 12″ | 8″ | 1.5 | 225 |
| 24″ | 8″ | 3 | 450 |
| 36″ | 8″ | 4.5 | 675 |
| 48″ | 8″ | 6 | 900 |
| 60″ | 8″ | 7.5 | 1125 |

TABLE II
Graphical Representation of the same formula for a 5″ × 7″ photograph.

| Final Size | | | Scan Dots |
|---|---|---|---|
| in Banner (Inches) | Original Size (Inches) | Multiple | per Inch (DPI) |
| 12″ | 5″ | 2.4 | 360 |
| 24″ | 5″ | 4.8 | 720 |
| 36″ | 5″ | 7.2 | 1080 |
| 48″ | 5″ | 9.6 | 1440 |
| 60″ | 5″ | 12 | 1800 |

For EPS and TIFF files, convert all fonts to “outlines”. Check for hidden characters in your artwork, signified by the infinity symbol (8 ).
To save a CDR file in CorelDraw, go to “select all” and click on “convert to curves”.
Do not be concerned with stuffing or zipping your file. All files sent go directly into our RIP software.
Proprietor uses FTP file transfers to upload your custom design. FTP transfers do not lose information and are well-suited for transferring files up to 100 MB.

Every inch on a file is a foot of banner. The file may be sent to the proprietor at ⅓ the final output size to allow you to manipulate and upload the file easier. This will allow a smaller file size for upload as well. For example, a final size banner of 9′×3′ would have a working design file size of 3′×1′.

Some typical FAQs appearing on the proprietor's site:

Q: Do I need to consider the difference between RGB and CMYK color formats?

A: No. This is not necessary because the proprietor does not separate your file into color planes.

Q: Can you print a bleed on my banner?

A: Yes, bleeds are included in the price of your banner. Design your banner artwork to extend through our bleed area, leaving [need number] inches beyond the boundaries of the banner.

Q: How do I avoid “banding” on large areas of black?

A: When you have large sections of black on your banner, you can avoid banding by setting your design software at: C=30, M=30, Y=0, K=100.

Big Photo Finish

With Big Photo Finish, the customer can create an amazing banner featuring up to three of his/her own photographs. Just upload your image(s), and follow the easy directions on the subsequent pages. Click here for information on uploading and file considerations.

Upload images . . .

1.
2.
3.
   To start: Select a horizontal or vertical banner.
   Then click Next.
   Big Banner Bazaar™
   Select the banner you want from the following categories

Events
New Baby

Holiday
Christmas
Thanksgiving

Personal
Birthday
New Baby

BIRTHDAY

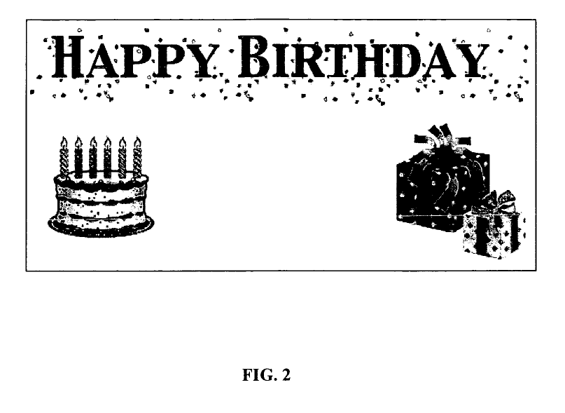

To place your order, click on the banner design you want. When Birthday is chosen, a banner having graphics similar to that illustrated in FIG. 2 may be displayed. In this way, a user may define parameters to create a printed medium.

Having described preferred embodiments of a new and improved method and system for a making and selling signs and charts, it is believed that other modifications, variations, and changes will be suggested to those skilled in the art in view of the teachings set forth herein. It is therefore to be understood that all such variations, modifications, and changes are believed to fall within the scope of the present invention as defined in the appended claims.

We claim

1. A method of enabling customers to visit a local site and configure a medium for printing comprising:
(a) providing interactive software configured to receive user defined preferences relating to one or more parameters for the medium;
(b) receiving the user-defined preferences at a host site located remote from the local site; and
(c) processing, via a host processing system, the defined parameters to generate a printed medium.

2. The method of claim 1, further comprising (d) receiving customer tendered payment and storing a record of the payment to provide a credited amount.

3. The method of claim 1 further comprising (e) delivering the printed medium to the customer located at the remote site.

4. An interactive system for enabling customers to customize a printed medium, the system comprising:
(a) interactive software operable to define the parameters of a medium to be printed;
(b) a processor operable to process user defined preferences relating to the medium parameters; and
(c) a printer configured to print the printed medium implementing the user defined parameters.

5. The interactive system of claim 4, wherein the printed medium is selected from the group consisting of a banner, a sign, and a card.

6. The interactive system of claim 4, wherein the parameters include at least one of graphics, indicia, a user-defined message, and a user-provided photo.

7. The interactive system of claim 4, wherein the software is adapted to run on a personal computer, and wherein the printer is located at a site remote from the printer.
